(19) United States
(12) Patent Application Publication
(10) Pub. No.: US 2018/0080788 A1
(43) Pub. Date: Mar. 22, 2018

(54) NAVIGATION BASED ON VEHICLE DIMENSIONS

(71) Applicant: Intel IP Corporation, Santa Clara, CA (US)

(72) Inventors: Archana Belvadi Shankaraiah, Bangalore (IN); Balaji Subramanyam Natakala, Bangalore (IN); Anshuman Pandey, Bangalore (IN); Sachin Kumar Prabodhkumar Vyas, Bangalore (IN)

(21) Appl. No.: 15/268,234

(22) Filed: Sep. 16, 2016

(51) Int. Cl. G01C 21/36; G01C 21/34

(52) U.S. Cl. CPC G01C 21/3626; G01C 21/3673; G01C 21/3453; G01C 21/3679

(57) ABSTRACT

A system for vehicle navigation may include a recognition circuit and a navigation circuit. The recognition circuit may determine a vehicle type based on received vehicle data. The navigation circuit may retrieve a navigation route between a starting location and a destination location, and modify the navigation route based on the determined vehicle type. The navigation circuit may also display a portion of the modified navigation route associated with a current location of the vehicle. The displayed portion of the navigation route may provide speed limit information based on the determined vehicle type. The recognition circuit may determine dimensions of the vehicle based on the vehicle data. The navigation circuit may determine parking information along the navigation route, based on the vehicle dimensions.

### TECHNICAL FIELD

Embodiments described herein generally relate to technical field of navigation systems, and in particular, to navigation based on vehicle dimensions.

### BACKGROUND

Current navigation systems do not adequately help a user navigate through areas associated with driving restrictions based on the vehicle type or dimensions. For example, some roads may have varying width and/or height restrictions making it prohibitive for certain vehicles to navigate through such areas. Additionally, current navigation systems do not provide assistance for locating parking suitable for the vehicle type or dimensions.

### BRIEF DESCRIPTION OF THE DRAWINGS

In the drawings, which are not necessarily drawn to scale, like numerals may describe similar components in differ rent views. Like numerals having different letter suffixes may represent different instances of similar components. Some embodiments are illustrated by way of example, and not limitation, in the figures of the accompanying drawings in which:

FIG. 1 is a diagram illustrating a navigation system, according to an embodiment;

FIG. 2 illustrates example navigation-related databases, according to an embodiment;

FIG. 3 illustrates example user interfaces for providing navigation and vehicle-related data, according to an embodiment;

FIG. 4A and FIG. 4B illustrate example navigation route selection based on vehicle dimensions, according to an embodiment;

FIG. 5 illustrates example speed limit information associated with different vehicle types, according to an embodiment;

FIG. 6 and FIG. 7 are flowcharts illustrating example methods for vehicle navigation, according to an embodiment; and

FIG. 8 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Disclosed herein are systems and methods that provide vehicle navigation between a starting location and a destination location based on vehicle dimensions. More specifically, a navigation database may be updated to store street width and height restrictions, details on parking areas (e.g., types and/or dimensions of vehicles that can park, size of individual parking spaces, etc.), speed limit information based on vehicle type, time restrictions for using a road based on vehicle type, weight restrictions for using certain roads, information on road bends (e.g., angle, width, and banking), a maximum turning radius that can be accommodated when negotiating turns, information on speed bumps (location, bumps height and width, etc.). The navigation database may then be used to modify a navigation route to avoid navigation on roads that are unsuitable for a specified vehicle type or dimension (e.g., road is too narrow or includes a turn that is too sharp), locate suitable parking area along the navigation route or in the vicinity of the destination location, avoid speed bump, and so forth. As used herein, the term “in the vicinity of” a given location, means the area within a pre-determined radius (e.g., 100 yards) of the given location.

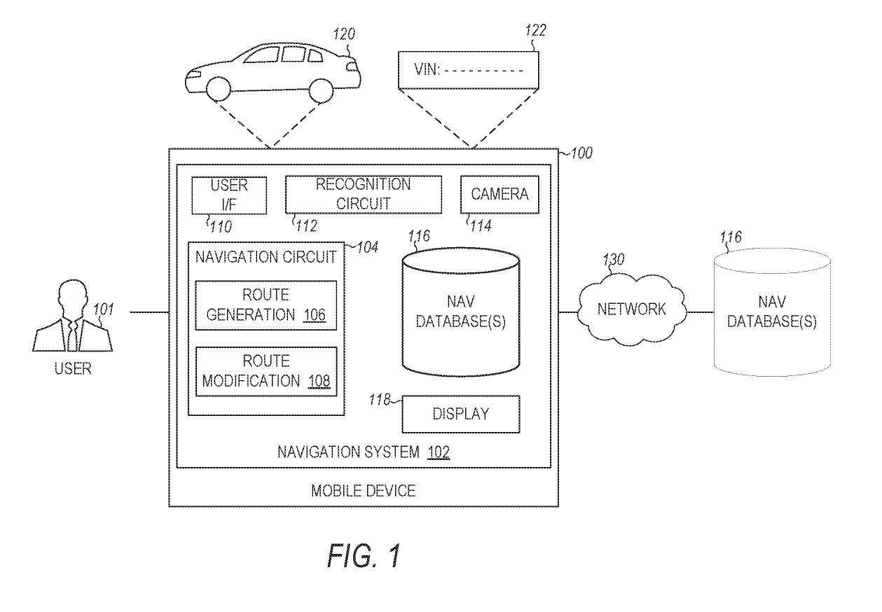

FIG. 1 is a diagram illustrating a navigation system 102, according to an embodiment. Referring to FIG. 1, the navigation system 102 may comprise a user interface (UI) module 110, a recognition circuit 112, a navigation circuit 104, and navigation databases 116. The navigation system 102 may be incorporated as part of a computing device 100, and may also utilize a camera 114 and a display 118 of the device 100. Examples of computing devises 100 include, but are not limited to, mobile phones (e.g., a smartphone), personal digital assistants, and tablet computers. It is contemplated that other types of computing devices 100 are also within the scope of the present disclosure.

The UI module 110 may comprise suitable circuitry, logic, interfaces and/or code and may be used to provide an interface to the user 101 for entering navigation data (e.g., a starting location and a destination location) as well as vehicle-related information (e.g., type of vehicle, vehicle dimensions, vehicle make/model, etc.) for use by the navigation circuit 104 and the recognition circuit 112. In an example, the vehicle-related information may be pre-programmed (e.g., as part of non-volatile memory) in instances when the navigation system 102 is implemented within a vehicle. The UI module 110 may further provide an interface for the user 101 to generate and/or update one or more of the navigation databases 116.

The recognition circuit 112 may comprise suitable circuitry, logic, interfaces and/or code and may be configured to determine vehicle dimensions and/or vehicle type based on received vehicle data. In an example embodiment, the user 101 may take a photo of the vehicle 120 (e.g., using camera 114), and the recognition circuit 112 may determine the vehicle 120 make and model based on the photo (e.g., based on a comparison of the vehicle outline/contour in the photo with known contours of vehicles). In another example embodiment, the user 101 may take a photo of the vehicle identification number (VIN) plate 122 of vehicle 120. The recognition circuit 112 may determine the vehicle make, model and year based on the VIN information. Once the vehicle make and model are determined, the recognition circuit 112 may determine the vehicle dimensions (e.g., width, length, and height) as well as other parameters associated with the vehicle (e.g., vehicle turning radius, vehicle weight, and so forth).

The navigation circuit 104 may comprise suitable circuitry, logic, interfaces and/or code and may be used to generate and/or modify a navigation route based on navigation data (e.g., starting location and a destination location) and vehicle data (e.g., vehicle type, dimensions or other vehicle data). In an example, the vehicle type can be one of: an automobile, a motorcycle, a truck, a bus, a mini-van, an electric-powered vehicle, a tractor-trailer, or a semi-trailer.

The navigation circuit 104 may comprise a route generation module 106 and a route modification module 108. The route generation module 106 may generate a navigation route based on the navigation data, or may retrieve the navigation route from one or more of the databases 116 (e.g., based on the starting and destination locations). The route modification module may modify the navigation route generated (or retrieved) by the route generation module 106.

In an example, the navigation circuit 104 may be configured to determine a starting location for a user 101. The starting location may be selected, entered, or otherwise provided by the user 101 (e.g., via UI 110). In some embodiments, the starting location may be determined from an electronic calendar event specifying a starting location for an upcoming trip, or from an email communication associated with an email (or social media) account of the user 101. In some embodiments, the starting location may be determined by the navigation circuit 104 using data obtained via the device 100. For example, the starting location may be the current location of user 101, which may be determined using Global Positioning System (GPS) technology, Global Navigation Satellite System (GNSS) technology, indoor positioning (e.g., using Wi-fi infrastructure), or other technologies for determining the current user location.

Similarly, the navigation circuit 104 may be configured to determine a destination location for the user 101. The destination location may be selected, entered, or otherwise provided by the user 101 (e.g., via UI 110). In some embodiments, the destination location may be determined from an electronic calendar even specifying a destination location for an upcoming trip, or from an email communication associated with an email (or social media) account of the user 101. It is contemplated that the starting and destination locations may be determined in other ways as well.

Even though the navigation system 102 is illustrated in FIG. 1 as incorporated within the device 100, one or more components of the navigation system 102 may be incorporated outside of the device 100 (e.g., as a separate device or database). For example, the navigation databases 116 may be cloud-based databases that can be accessed by the device 100 via network 130. Examples of communication networks include, but are not limited to, a LAN, a WAN, the Internet, mobile telephone networks, and wireless data networks (e.g., Wi-Fi and. WiMAX networks). It is contemplated that other types of communication networks 130 are also within the scope of the present disclosure.

In an example, the navigation system 102 may be part of a self-driving vehicle (e.g., 120). In this regard, the functionalities performed by the user 101 in connection with entering vehicle-related data may be performed automatically by one or more processors of the navigation system 102 (e.g., detect vehicle make/model automatically based on the VIN number, e

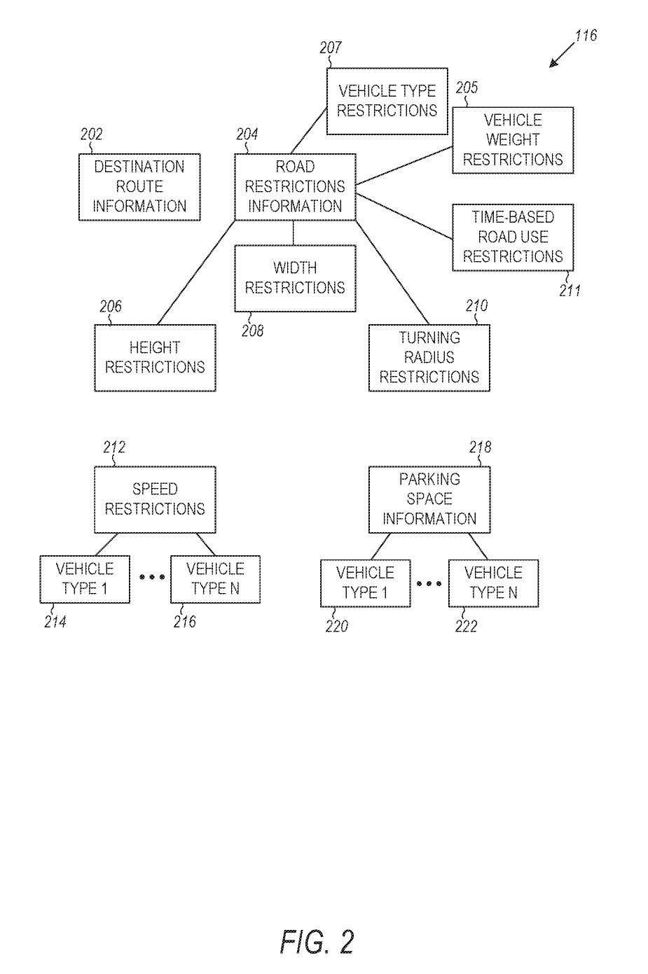

FIG. 2 illustrates example navigation-related databases 116, according to an embodiment. Referring to FIG. 2, the navigation databases 116 may include destination route information 202, road restrictions information 204, speed restriction information 212, and parking space information 218.

The destination route information 202 may include information on navigation routes between a specified starting location and a destination location. The information 202 may be a proprietary database (e.g., updated by a navigation services company), and may be further updated by the user 101 and/or via crowdsourcing (e.g., by updates from one or more users subscribing to use the information 202).

The road restrictions information 204 may provide various restrictions associated with a navigation route. For example, the road restriction information 204 may include vehicle weight restrictions 205, vehicle height restrictions 206, vehicle type restrictions 207, vehicle width restrictions 208, turning radius restrictions 210, and time-based road use restrictions 211.

The turning radius restrictions 210 may include information about a maximum turning radius that is associated with a vehicle type for successfully negotiating a turn in a navigation route. The turning radius restriction information 210 may be organized based on vehicle type, for turns along various navigation routes (e.g., turns in navigation routes within the database 202).

The time-based road use restrictions 211 may include information on road use restrictions associated with a navigation route. For example, a street in downtown may be closed during specific times. The vehicle type restrictions 207 may indicate road closures based on vehicle type. For example, a street in a city center district may be closed for certain vehicle types (e.g., heavy vehicles).

The speed restrictions database 212 may include information identifying speed limits (e.g., minimum or maximum allowed speed) along a navigation route. The speed limit information may be organized based on vehicle type (e.g., speed limit information 214, . . . , 216 is associated with vehicles of types 1, . . . , N, respectively). The speed restrictions database 212 may also be organized based on vehicle dimensions, or other criteria.

The parking space information 218 may include information identifying locations of parking areas (e.g., outdoor and indoor) along navigation routes (e.g., routes from the database 202). The parking space information 218 may be organized based on vehicle type (e.g., parking space information 220, . . . , 222 suitable for vehicles of types 1, . . . , N, respectively). The parking space information 218 may also be organized based on vehicle dimensions, or other criteria.

In an example, the navigation databases 116 may include additional types of navigation-related information not illustrated in FIG. 2. For example, the navigation databases 116 may further include information about speed bumps (e.g., location and dimensions of speed bumps), roundabouts, and other navigation related information.

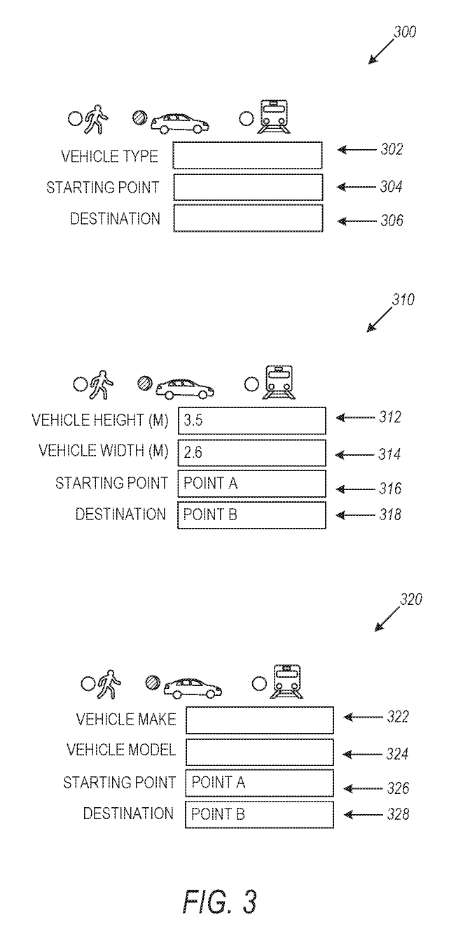

FIG. 3 illustrates example user interfaces for providing navigation and vehicle-related data, according to an embodiment. Referring to FIG. 3, the example user interfaces 300 and 310 may be provided by the user interface block 110 within the navigation system 102. The user interface 300 may include a selection of the mode of transportation (e.g., walking, vehicle, or public transport). In instances when vehicle is selected, the interface 300 may further include vehicle type selection 302, a starting point selection 304, and a destination selection 306.

The user interface 310 may include a selection of the mode of transportation (e.g., walking, vehicle, or public transport). In instances when vehicle is selected, the interface 310 may further include vehicle height selection 312, vehicle width selection 314, a starting point selection 316, and a destination selection 318.

The user interface 320 may include a selection of the mode of transportation (e.g., walking, vehicle, or public transport). In instances when vehicle is selected, the interface 320 may further include vehicle make selection 322, vehicle model selection 324, a starting point selection 326, and a destination selection 328.

Even though only three user interfaces are illustrated in FIG. 3, the disclosure is not limited in this regard, and other types of vehicle-related information may be entered by a user. For example, a user may enter a vehicle identification number (VIN) or a photograph of the vehicle. The navigation system 102 may then determine vehicle dimensions and/or type based on the vehicle-related information (e.g., VIN or photograph of the vehicle).

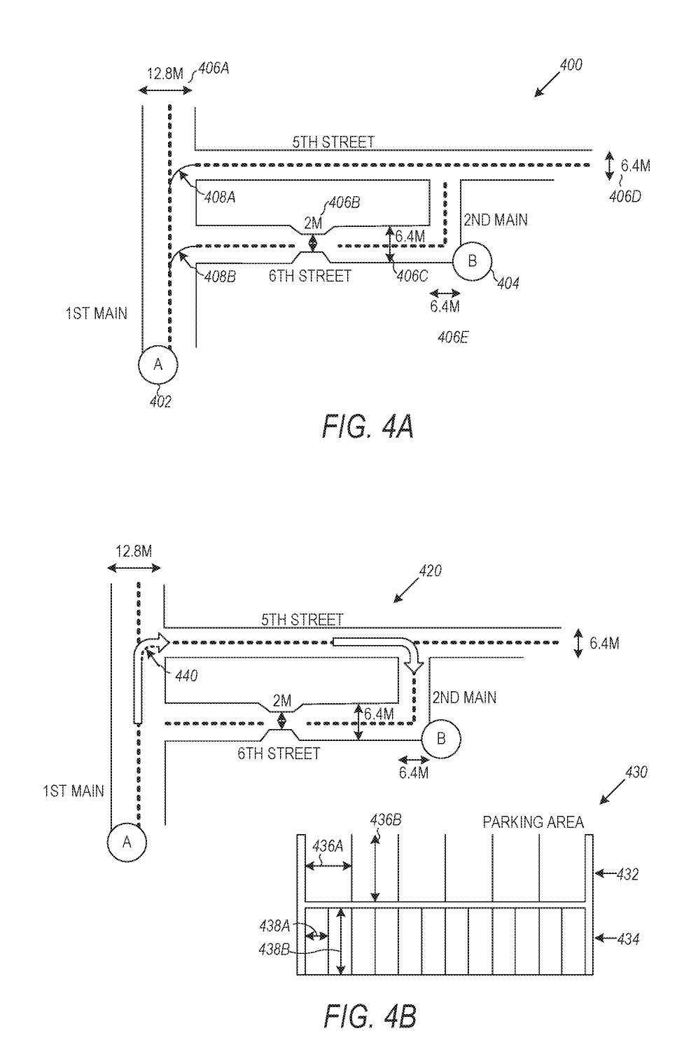

FIG. 4A and FIG. 4B illustrate example navigation route selection based on vehicle dimensions, according to an embodiment. Referring to FIG. 4A, there is illustrated an example navigation route 400 between a starting location (A) 402, and a destination location (B) 404 (e.g., as provided by a user using the interface 310). The navigation system 102 may use the route information database 202 to retrieve a map including navigation routes between locations A 402 and B 404. Additionally, the navigation system 102 may retrieve various restrictions associated with the retrieved navigation routes between A and B. For example, the navigation system 102 may retrieve vehicle width restrictions 406a 406e associated with various roads along the navigation routes between A 402 and B 404.

In an example embodiment, the navigation system 102 may also retrieve (e.g., from database 210) turning radius information (e.g., 408a and 408b) associated with the navigation routes. For example, turning radius 408a indicates a maximum turning radius for a vehicle to negotiate a turn from “1^{st} Main Street” to “5^{th} Street”. Similarly, turning radius 408b indicates a maximum turning radius for a vehicle to negotiate a turn from “1^{st} Main Street” to “6^{th} Street”.

FIG. 4B illustrates a modified navigation route 420, based on the received vehicle dimensions using interface 310. More specifically, a user has indicated that a trip from point A to point B will use a vehicle with width of 2.6 meters (m) and height of 3.5 meters. The navigation system 102 may initially retrieve the route from point A to pass through 6^{th} Street (as this is the shortest route from A to B). However, the navigation system 102 may also determine that the vehicle will not be able to pass through 6^{th} Street as there is a portion that is only 2 meters wide. The navigation system 102 may then modify the navigation route from A to go through 5^{th} Street instead.

In an example embodiment, the navigation system 102 may determine the turning radius 440 associated with the user's vehicle (e.g., based on the dimensions entered in 312 and 314, or based on the vehicle type entered in 302). The navigation system 102 may then further modify the route from A to B based on the determined vehicle radius 440. In the example illustrated in FIG. 4B, the turning radius 440 is smaller than the maximum turning radius 408a associated with the turn from 1^{st} Main Street to 5^{th} Street and, therefore, the route from A to B may go through 5^{th} Street. The vehicle width restrictions 406a-406e, the maximum turning radius restrictions 408a-408b, and any other restrictions associated with the navigation route, may be displayed along relevant portions of the navigation route.

In an example embodiment, navigation system 102 may further modify the retrieved route from point A to point B by including parking area information 430 that is compatible with the vehicle dimensions entered by user at interface 310. The parking area information 430 may indicate a parking lot located near the destination point B or along the route from A to B. The parking area may include parking areas 432 and 434 for different types (or sizes) of vehicles (e.g., 432 may be for regular automobiles, and 434 may be for compact automobiles). Additionally, the parking area information 430 may include width and length dimensions (436a, 436b, 438a, 438b) of individual parking spaces within areas 432 and 434. The route modification circuit 108 may further modify a selected navigation route so that a parking area is provided at the destination location (e.g., at a pre-determined radius within the destination location) (or another location selected by the user), where the parking area includes parking spaces with dimensions that are compatible with the user's vehicle.

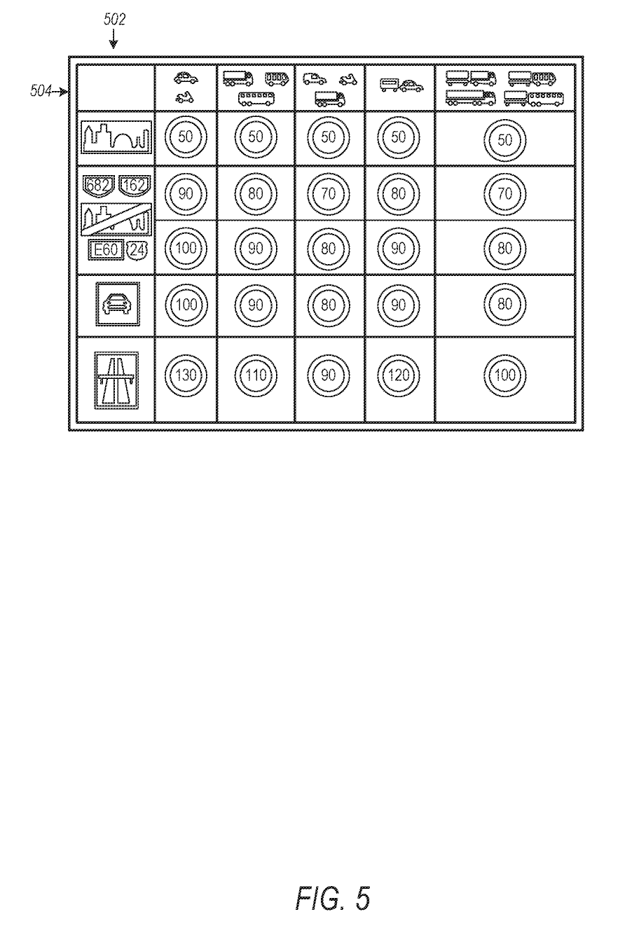

FIG. 5 illustrates example speed limit information associated with different vehicle types, according to an embodiment. Referring to FIG. 5, there are example speed restrictions (e.g., as stored in database 212). The speed restrictions may be organized based on the vehicle type 504 as well as the type of road 502.

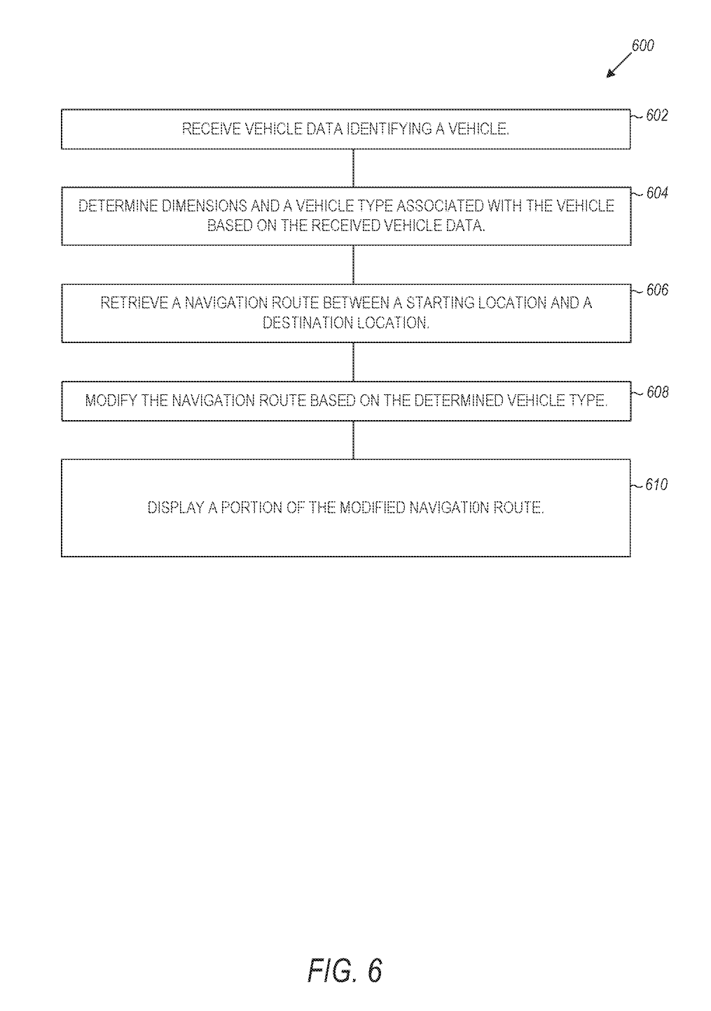

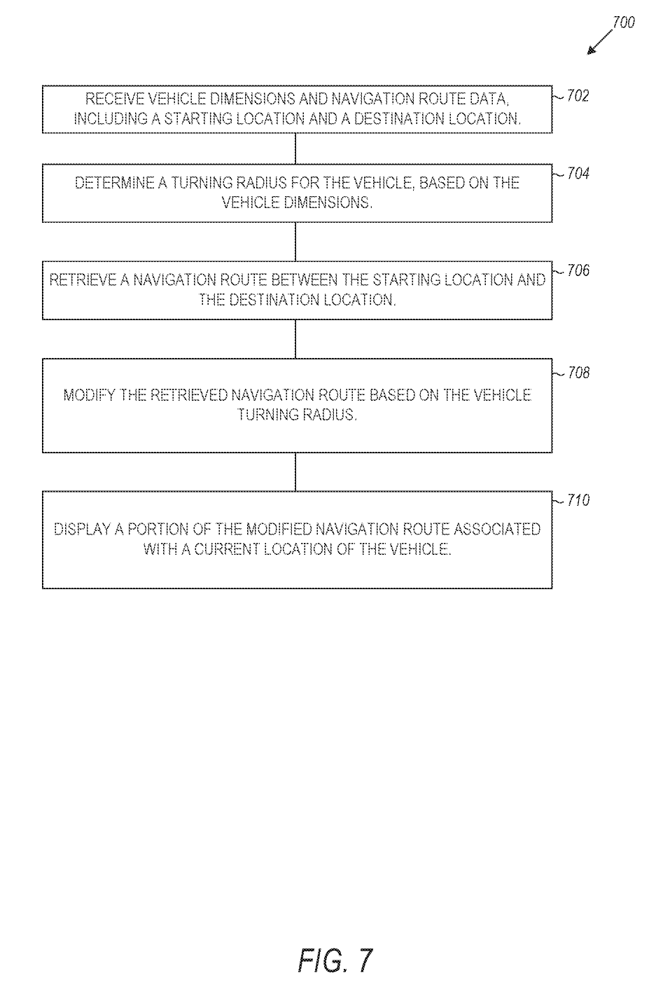

FIG. 6 and FIG. 7 are flowcharts illustrating example methods for vehicle navigation, according to an embodiment. Referring to FIG. 6, the example method 600 may start at 602, when vehicle data identifying a vehicle may be received. At 604, vehicle type associated with the vehicle may be determined based on the received vehicle data. At 606, a navigation route between a starting location and a destination location may be retrieved. At 608, the navigation route may be modified based on the determined vehicle type. At 610, a portion of the modified navigation route associated with a current location of the vehicle may be displayed. The displayed portion of the navigation route may provide speed limit information based on the determined vehicle type.

In an example embodiment, a user may enter vehicle-related information, such as the make, model and year of the vehicle or the vehicle VIN. The user may further enter a starting location (e.g., point A) and a destination location (e.g., point B). The navigation system 102 (e.g., the recognition circuit 112) may determine the vehicle type and/or the dimensions of the vehicle based on the entered vehicle-related information. The vehicle type may be one of: an automobile, a motorcycle, a truck, a bus, a mini-van, an electric-powered vehicle, a tractor-trailer, or a semi-trailer.

Once the vehicle dimensions and/or type are determined, the navigation system 102 may retrieve a navigation route between locations A and B using, e.g., the destination route information database 202. Based on the vehicle dimensions (or based on the vehicle type), the navigation system 102 may determine that the vehicle is a bus, and at least a portion of the retrieved navigation route between A and B has a road use restriction associated with busses (e.g., a vehicle weight restriction, vehicle width restriction or a time-based road use restriction for a given road). For example, 6^{th} Street in FIG. 4B may have a width restriction as well as a time-based road use restriction (e.g., no busses allowed during the time the proposed travel will take place). The navigation system 102 may modify the navigation route from A to B by routing the bus through 5^{th} Street (which is without any bus-related restrictions) instead of 6^{th} Street. The navigation system 102 may further display the modified navigation route, and may annotate the modified route to the user 101 with applicable vehicle-related restrictions for specific portions of the route (e.g., restrictions of the initial route can be displayed along the initial route, and any new restrictions with the modified route may be displayed as well).

Referring to FIG. 7, the example method 700 may start at 702, when vehicle dimensions and navigation route data may be received. The navigation route data may include a starting location and a destination location. At 704, a turning radius for the vehicle may be determined, based on either the vehicle dimensions or vehicle make-model (e.g., as explained herein below). At 706, a navigation route between the starting location and the destination location may be retrieved. At 708, the retrieved navigation route may be modified based on the vehicle turning radius. The vehicle turning radius may conform to a maximum turning radius associated with the modified navigation route (i.e., the vehicle turning radius may be smaller than the maximum turning radius for a specific turn, which means the vehicle can negotiate the turn). At 710, a portion of the modified navigation route associated with a current location of the vehicle may be displayed. The displayed portion of the navigation route may provide the maximum turning radius associated with the modified navigation route.

In an example embodiment, a user may enter vehicle dimensions as well as a starting location and a destination location (e.g., using interface 310). Once the vehicle dimensions and starting/destination locations are received, the navigation system 102 may determine a turning radius for the user's vehicle (e.g., based on the vehicle dimensions).

As used herein, the term “turning radius” indicates the radius of the smallest circular turn that the vehicle is capable of making. For example, the smallest circular turn can be performed when the steering wheel is turned all the way to one side (i.e., the front wheels have a maximum turning angle). In an example, the vehicle turning radius may be determined based on the wheelbase distance (w), which is the distance between the center of the front and rear wheels, as well as the maximum turning angle (alpha) of the front wheels. Knowing the vehicle type or model-make or dimensions may be used to retrieve the parameters w and alpha (e.g., from an automotive data source or calculate based on the dimensions). A turning radius (R) may then be determined by dividing w by sin(alpha).

The navigation system 102 may retrieve a navigation route between locations A and B using, e.g., the destination route information database 202. Based on the vehicle dimensions, the navigation system 102 may determine that a turn in the retrieved navigation route has a turning radius restriction (e.g., based on information from database 210), with the vehicle turning radius being bigger than the maximum turning radius associated with the specific road turn. A vehicle turning radius being bigger than a maximum turning radius for a road curve indicates that the vehicle may not be able to negotiate the curve and make the turn.

The navigation system 102 may modify the navigation route from A to B by routing the vehicle (e.g., bus) through other roads that have a maximum turning radius that is higher than the vehicle's turning radius. The navigation system 102 may further display the modified navigation route, and may annotate to the user 101 the modified route with applicable vehicle-related restrictions for specific portions of the route (e.g., turning radius restrictions)

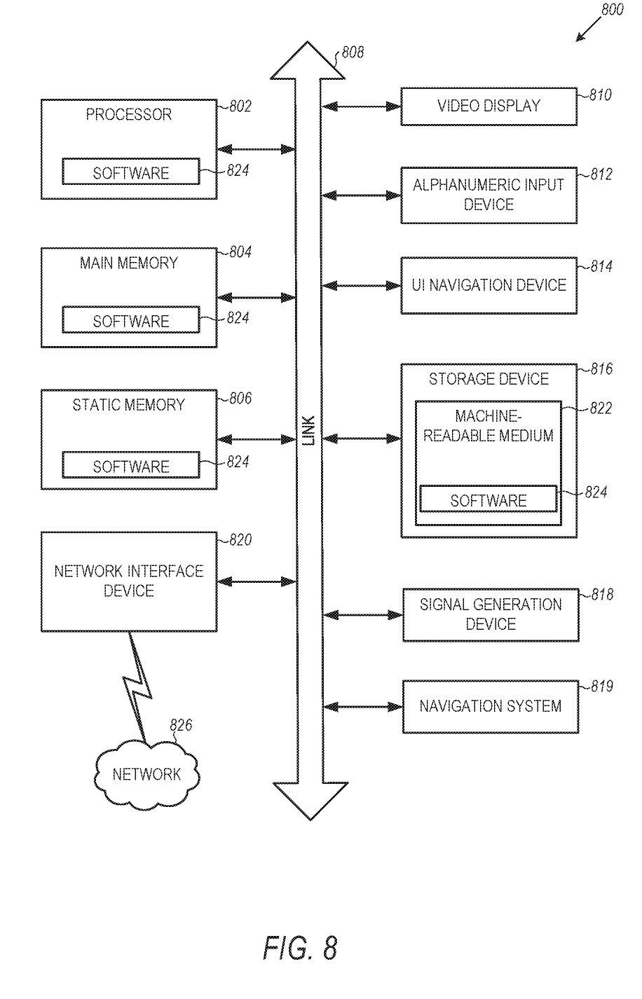

FIG. 8 is a block diagram illustrating a machine in the example form of a computer system 800, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 800 includes at least one processor 802 (e.g., a central processing unit (CPU), a graphics processing unit (GPU) or both, processor cores, compute nodes, etc.), a main memory 804 and a static memory 806, which communicate with each other via a link 808 (e.g., bus). The computer system 800 may further include a video display unit 810, an alphanumeric input device 812 (e.g., a keyboard), and a user interface (UI) navigation device 814 (e.g., a mouse). In one embodiment, the video display unit 810, input device 812 and UI navigation device 814 are incorporated into a touch screen display. The computer system 800 may additionally include a storage device 816 (e.g., a drive unit), a signal generation device 818 (e.g., a speaker), a network interface device 820, and one or more sensors (not shown), such as a global positioning system (GPS) sensor, compass, accelerometer, pyrometer, magnetometer, barometer, temperature sensor or other sensors.

In an example embodiment, the computer system 800 may further include a navigation system 819, which may have functionalities similar to the navigation system 102 described in reference to FIG. 1.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the computer system 800, with the main memory 804, static memory 806, and the processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Additional Notes & Examples:

Example 1 is a system for vehicle navigation, the system comprising: a recognition circuit to determine a vehicle type based on received vehicle data; and a navigation circuit to: retrieve a navigation route between a starting location and a destination location; modify the navigation route based on the determined vehicle type; and display a portion of the modified navigation route associated with a current location of the vehicle, the displayed portion of the navigation route providing speed limit information based on the determined vehicle type.

In Example 2, the subject matter of Example 1 optionally includes wherein: the recognition circuit determines dimensions of the vehicle based on the vehicle data; and the navigation circuit determines parking information along the navigation route, based on the vehicle dimensions.

In Example 3, the subject matter of Example 2 optionally includes wherein to determine the parking information, the navigation circuit is to select a parking location from a plurality of available parking locations in the vicinity of the destination location based on the vehicle dimensions and dimensions of parking spaces within the parking location.

In Example 4, the subject matter of any one or more of Examples 2-3 optionally include wherein to retrieve the navigation route, the navigation circuit is to select the navigation route from a plurality of navigation routes based on the vehicle dimensions.

In Example 5, the subject matter of any one or more of Examples 2-4 optionally include wherein to modify the navigation route, the navigation circuit is to: determine a vehicle turning radius based on the vehicle dimensions; and modify the selected navigation route based on the vehicle turning radius, wherein the vehicle turning radius conforms to a maximum turning radius associated with the modified navigation route.

In Example 6, the subject matter of Example 5 optionally includes wherein the navigation circuit is to display the vehicle turning radius and the maximum turning radius associated with the modified navigation route.

In Example 7, the subject matter of any one or more of Examples 1-6 optionally include wherein the vehicle data includes a vehicle identification number (VIN).

In Example 8, the subject matter of any one or more of Examples 1-7 optionally include wherein the vehicle data includes year, make and model of the vehicle.

In Example 9, the subject matter of any one or more of Examples 1-8 optionally include wherein the vehicle type is one of: an automobile, a motorcycle, a truck, a bus, a mini-van, an electric-powered vehicle, a tractor-trailer, or a semi-trailer.

In Example 10, the subject matter of Example 9 optionally includes wherein to modify the navigation route, the navigation circuit is to: determine the speed limit information associated with the vehicle type; and modify the navigation route based on the determined speed limit information.

In Example 11, the subject matter of any one or more of Examples 9-10 optionally include wherein to modify the navigation route, the navigation circuit is to: determine time-based road use restrictions associated with the vehicle type; and modify the navigation route based on the determined road use restrictions.

In Example 12, the subject matter of any one or more of Examples 1-11 optionally include wherein to modify the navigation route, the navigation circuit is to: retrieve a time-based road usage restriction associated with a portion of the navigation route; and modify the navigation route based on the time-based road usage restriction.

In Example 13, the subject matter of Example 12 optionally includes wherein the navigation circuit is to display the time-based road usage restriction along with the portion of the navigation route.

Example 14 is a method for vehicle navigation between a starting location and a destination location, the method comprising: using a processor of a computing device: receiving vehicle data identifying a vehicle; determining a vehicle type associated with the vehicle based on the received vehicle data; retrieving a navigation route between the starting location and the destination location; modifying the navigation route based on the determined vehicle type; and displaying a portion of the modified navigation route associated with a current location of the vehicle, the displayed portion of the navigation route providing speed limit information based on the determined vehicle type.

In Example 15, the subject matter of Example 14 optionally includes determining dimensions of the vehicle based on the vehicle data; and determining parking information along the navigation route, based on the vehicle dimensions.

In Example 16, the subject matter of Example 15 optionally includes selecting a parking location from a plurality of available parking locations in the vicinity of the destination location based on the vehicle dimensions and dimensions of parking spaces within the parking location.

In Example 17, the subject matter of any one or more of Examples 15-16 optionally include wherein the retrieved navigation route is associated with height and width restrictions.

In Example 18, the subject matter of Example 17 optionally includes modifying the navigation route based on the vehicle dimensions, wherein the vehicle dimensions conform to the height and width restrictions of the modified navigation route.

In Example 19, the subject matter of any one or more of Examples 15-18 optionally include determining a vehicle turning radius based on the vehicle dimensions; and modifying the selected navigation route based on the vehicle turning radius, wherein the vehicle turning radius conforms to a maximum turning radius associated with the modified navigation route.

In Example 20, the subject matter of any one or more of Examples 14-19 optionally include wherein the vehicle data includes a vehicle identification number (VIN).

In Example 21, the subject matter of any one or more of Examples 14-20 optionally include wherein the vehicle data includes year, make and model of the vehicle.

In Example 22, the subject matter of any one or more of Examples 14-21 optionally include wherein the vehicle type is one of: an automobile, a motorcycle, a truck, a bus, a mini-van, an electric-powered vehicle, a tractor-trailer, or a semi-trailer.

In Example 23, the subject matter of Example 22 optionally includes determining the speed limit information associated with the vehicle type; and modifying the navigation route based on the determined speed limit information for the vehicle type.

In Example 24, the subject matter of any one or more of Examples 14-23 optionally include retrieving a time-based road usage restriction associated with a current location of the vehicle along the navigation route; and modifying the navigation route based on the time-based road usage restriction.

In Example 25, the subject matter of Example 24 optionally includes displaying the time-based road usage restriction along with the current location of the vehicle along the navigation route.

Example 26 is at least one machine-readable medium that, when executed by a machine, causes the machine to perform any of the methods of Examples 14-25.

Example 27 is a device comprising means to perform any of the methods of Examples 14-25.

Example 28 is a device for generating a navigation route between a starting location and a destination location, the device comprising: means for receiving vehicle data identifying a vehicle; means for determining a vehicle type associated with the vehicle based on the received vehicle data; means for retrieving a navigation route between the starting location and the destination location; means for modifying the navigation route based on the determined vehicle type; and means for displaying a portion of the modified navigation route associated with a current location of the vehicle, the displayed portion of the navigation route providing speed limit information based on the determined vehicle type.

In Example 29, the subject matter of Example 28 optionally includes means for determining dimensions of the vehicle; and means for determining parking information along the navigation route, based on the vehicle dimensions.

In Example 30, the subject matter of Example 29 optionally includes means for selecting a parking location from a plurality of available parking locations in the vicinity of the destination location based on the vehicle dimensions and dimensions of parking spaces within the parking location.

In Example 31, the subject matter of any one or more of Examples 29-30 optionally include wherein the retrieved navigation route is associated with height and width restrictions.

In Example 32, the subject matter of Example 31 optionally includes means for modifying the navigation route based on the vehicle dimensions, wherein the vehicle dimensions conform to the height and width restrictions of the modified navigation route.

In Example 33, the subject matter of any one or more of Examples 29-32 optionally include means for determining a vehicle turning radius based on the vehicle dimensions; and means for modifying the selected navigation route based on the vehicle turning radius, wherein the vehicle turning radius conforms to a maximum turning radius associated with the navigation route.

In Example 34, the subject matter of any one or more of Examples 28-33 optionally include wherein the vehicle data includes a vehicle identification number

In Example 35, the subject matter of any one or more of Examples 28-34 optionally include wherein the vehicle data includes year, make and model of the vehicle.

In Example 36, the subject matter of any one or more of Examples 28-35 optionally include wherein the vehicle type is one of: an automobile, a motorcycle, a truck, a bus, a mini-van, an electric-powered vehicle, a tractor-trailer, or a semi-trailer.

In Example 37, the subject matter of Example 36 optionally includes means for determining the speed limit information associated with the vehicle type; and means for modifying the navigation route based on the determined speed limit information for the vehicle type.

In Example 38, the subject matter of any one or more of Examples 28-37 optionally include means for retrieving a time-based road usage restriction associated with a current location of the vehicle along the navigation route; and means for modifying the navigation route based on the time-based road usage restriction.

In Example 39, the subject matter of Example 38 optionally includes means for displaying the time-based road usage restriction along with the current location of the vehicle along the navigation route.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for vehicle navigation, the system comprising:
a recognition circuit to determine a vehicle type based on received vehicle data; and
a navigation circuit to:
retrieve a navigation route between a starting location and a destination location;
modify the navigation route based on the determined vehicle type; and
display a portion of the modified navigation route associated with a current location of the vehicle, the displayed portion of the navigation route providing speed limit information based on the determined vehicle type.

2. The system according to claim 1, wherein:
the recognition circuit determines dimensions of the vehicle based on the vehicle data; and
the navigation circuit determines parking information along the navigation route, based on the vehicle dimensions.

3. The system according to claim 2, wherein to determine the parking information, the navigation circuit is to select a parking location from a plurality of available parking locations in the vicinity of the destination location based on the vehicle dimensions and dimensions of parking spaces within the parking location.

4. The system according to claim 2, wherein to retrieve the navigation route, the navigation circuit is to select the navigation route from a plurality of navigation routes based on the vehicle dimensions.

5. The system according to claim 2, wherein to modify the navigation route, the navigation circuit is to:
determine a vehicle turning radius based on the vehicle dimensions; and
modify the selected navigation route based on the vehicle turning radius, wherein the vehicle turning radius conforms to a maximum turning radius associated with the modified navigation route.

6. The system according to claim 5, wherein the navigation circuit is to display the vehicle turning radius and the maximum turning radius associated with the modified navigation route.

7. The system according to claim 1, wherein the vehicle data includes a vehicle identification number (VIN).

8. The system according to claim 1, wherein the vehicle data includes year, make and model of the vehicle.

9. The system according to claim 1, wherein the vehicle type is one of: an automobile, a motorcycle, a truck, a bus, a mini-van, an electric-powered vehicle, a tractor-trailer, or a semi-trailer.

10. The system according to claim 9, wherein to modify the navigation route, the navigation circuit is to:
determine the speed limit information associated with the vehicle type; and
modify the navigation route based on the determined speed limit information.

11. A method for vehicle navigation between a starting location and a destination location, the method comprising:
using a processor of a computing device:
receiving vehicle data identifying a vehicle;
determining a vehicle type associated with the vehicle based on the received vehicle data;
retrieving a navigation route between the starting location and the destination location;
modifying the navigation route based on the determined vehicle type; and
displaying a portion of the modified navigation route associated with a current location of the vehicle, the displayed portion of the navigation route providing speed limit information based on the determined vehicle type.

12. The method according to claim 11, further comprising:
determining dimensions of the vehicle based on the vehicle data; and
determining parking information along the navigation route, based on the vehicle dimensions.

13. The method according to claim 12, further comprising:
selecting a parking location from a plurality of available parking locations in the vicinity of the destination location based on the vehicle dimensions and dimensions of parking spaces within the parking location.

14. The method according to claim 12, wherein the retrieved navigation route is associated with height and width restrictions.

15. The method according to claim 14, further comprising:
modifying the navigation route based on the vehicle dimensions, wherein the vehicle dimensions conform to the height and width restrictions of the modified navigation route.

16. The method according to claim 12, further comprising:
determining a vehicle turning radius based on the vehicle dimensions; and
modifying the selected navigation route based on the vehicle turning radius, wherein the vehicle turning radius conforms to a maximum turning radius associated with the modified navigation route.

17. The method according to claim 11, wherein the vehicle data includes a vehicle identification number (VIN).

18. The method according to claim 11, wherein the vehicle data includes year, make and model of the vehicle.

19. The method according to claim 11, wherein the vehicle type is one of: an automobile, a motorcycle, a truck, a bus, a mini-van, an electric-powered vehicle, a tractor-trailer, or a semi-trailer.

20. The method according to claim 19, further comprising:
determining the speed limit information associated with the vehicle type; and
modifying the navigation route based on the determined speed limit information for the vehicle type.

21. The method according to claim 11, further comprising:
retrieving a time-based road usage restriction associated with a current location of the vehicle along the navigation route; and
modifying the navigation route based on the time-based road usage restriction.

22. At least one machine-readable medium including instructions, which when executed by a machine, cause the machine to:
receive vehicle data identifying a vehicle;
determine a vehicle type associated with the vehicle based on the received vehicle data;
retrieve a navigation route between the starting location and the destination location;
modify the navigation route based on the determined vehicle type; and
display a portion of the modified navigation route associated with a current location of the vehicle, the displayed portion of the navigation route providing speed limit information based on the determined vehicle type.

23. The machine-readable medium according to claim 22, further including instructions to:
determine dimensions of the vehicle based on the vehicle data; and
determine parking information along the navigation route, based on the vehicle dimensions.

24. The machine-readable medium according to claim 23, further including instructions to:
select a parking location from a plurality of available parking locations in the vicinity of the destination location based on the vehicle dimensions and dimensions of parking spaces within the parking location.

25. The machine-readable medium according to claim 23, wherein the retrieved navigation route is associated with height and width restrictions.
